(19) United States
(12) Patent Application Publication
(10) Pub. No.: US 2026/0261675 A1
(43) Pub. Date: Sep. 3, 2026

(54) METHOD AND APPARATUS FOR VIDEO CODING USING META INFORMATION

(71) Applicants: HYUNDAI MOTOR COMPANY, Seoul (KR); KIA CORPORATION, Seoul (KR); EWHA UNIVERSITY – INDUSTRY COLLABORATION FOUNDATION, Seoul (KR)

(72) Inventors: Je Won Kang, Seoul (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); EWHA UNIVERSITY – INDUSTRY COLLABORATION FOUNDATION, Seoul (KR)

(21) Appl. No.: 18/875,995

(22) PCT Filed: Jun. 13, 2023
(86) PCT No.: PCT/KR2023/008133

§ 371 Date: Dec. 17, 2024

(30) Foreign Application Priority Data
Jun. 22, 2022 (KR) 10-2022-0075990
Jun. 12, 2023 (KR) 10-2023-0074954

(51) Int. Cl. H04N 19/124; H04N 19/105; H04N 19/159; H04N 19/176; H04N 19/196; H04N 19/70

(52) U.S. Cl. CPC H04N 19/124; H04N 19/105; H04N 19/159; H04N 19/176; H04N 19/196; H04N 19/70

(57) ABSTRACT

A method and a device for video coding using meta information. In particular, a video decoding device decodes compression parameters for a current block from a bitstream and generates meta information by combining one or more of the compression parameters. The meta information comprises each compression parameter without modification or comprises a meta information vector generated from each compression parameter. The video decoding device generates a feature vector of the meta information by inputting the meta information into a deep learning-based extraction model and performs a decoding process for the current block by using the feature vector.

### CROSS-REFERENCE TO RELATED APPLICATIONS

This application is a U.S. national stage of International Application No. PCT/KR2023/008133, filed on Jun. 13, 2023, which claims priority to Korean Patent Application No. 10-2022-0075990, filed on Jun. 22, 2022, and Korean Patent Application No. 10-2023-0074954, filed on Jun. 12, 2023, the entire contents of each of which are hereby incorporated herein by reference.

### TECHNICAL FIELD

The present disclosure relates to a video coding method and an apparatus using meta information.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

Meta information is defined as a combination of one or more parameters used in the video encoding and decoding processes, such as block structure, intra prediction, inter prediction, quantization parameter, and motion vector. The feature vector derived from the meta information may then be used for video encoding/decoding. Therefore, to improve video encoding efficiency and video quality, a method for efficiently deriving feature vectors from meta information and a method for efficiently utilizing the feature vectors need to be considered.

### SUMMARY

The present disclosure seeks to provide a video coding method and an apparatus for extracting feature vectors from meta information by using a deep leaning-based extraction model. The video coding method and the apparatus use the extracted feature vector for video encoding/decoding.

At least one aspect of the present disclosure provides a method for reconstructing a current block, performed by an video decoding device. The method includes decoding compression parameters for the current block from a bitstream. The method also includes generating meta information by combining one or more of the compression parameters. Here, the meta information comprises each compression parameter without modification or comprises a meta information vector generated from each compression parameter. The method also includes generating a feature vector of the meta information by inputting the meta information into a deep learning-based extraction model. The method also includes performing a decoding process for the current block by using the feature vector.

Another aspect of the present disclosure provides a method for encoding a current block, performed by an video encoding device. The method includes obtaining compression parameters for the current block. The method also includes generating meta information by combining one or more of the compression parameters. Here, the meta information comprises each compression parameter without modification or comprises a meta information vector generated from each compression parameter. The method also includes generating a feature vector of the meta information by inputting the meta information into a deep learning-based extraction model. The method also includes performing an encoding process for the current block by using the feature vector.

Yet another aspect of the present disclosure provides a computer-readable recording medium storing a bitstream generated by an video encoding method. The video encoding method includes obtaining compression parameters for current block. The video encoding method also includes generating meta information by combining one or more of the compression parameters. Here, the meta information comprises each compression parameter without modification or comprises a meta information vector generated from each compression parameter. The video encoding method also includes generating a feature vector of the meta information by inputting the meta information into a deep learning-based extraction model. The video encoding method also includes performing an encoding process for the current block by using the feature vector.

As described above, the present disclosure provides a video coding method and an apparatus that extract feature vectors from meta information by using a deep learning-based extraction model and utilize the extracted feature vectors for video encoding/decoding. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 illustrates matrix weighted intra prediction.

FIG. 7 illustrates a feed-forward network as a deep learning-based neural network.

FIG. 8 illustrates an video decoding device that uses meta information according to one embodiment of the present disclosure.

FIG. 9 illustrates the use of meta information according to one embodiment of the present disclosure.

FIG. 10 illustrates the use of meta information according to another embodiment of the present disclosure.

FIG. 11 illustrates a method for encoding a current block performed by an video encoding device according to one embodiment of the present disclosure.

FIG. 12 illustrates a method for decoding a current block performed by an video decoding device according to one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

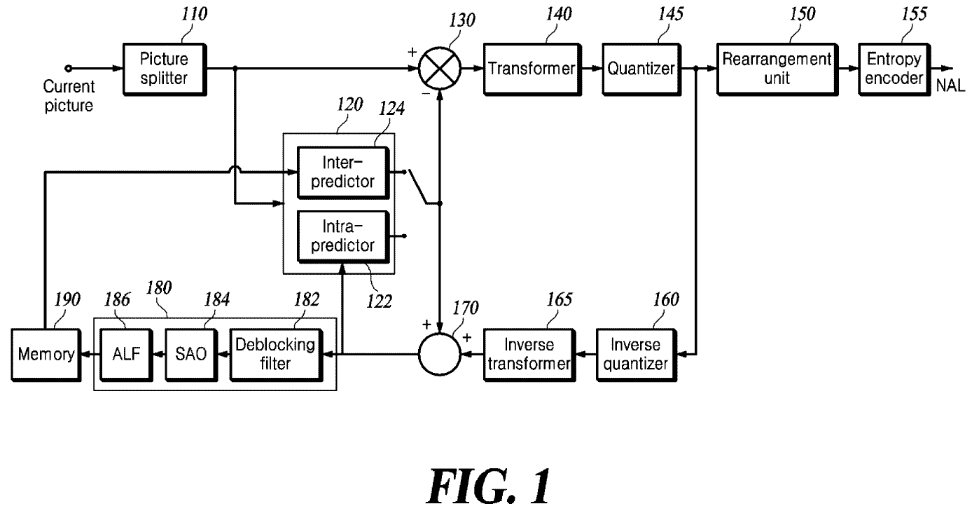

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

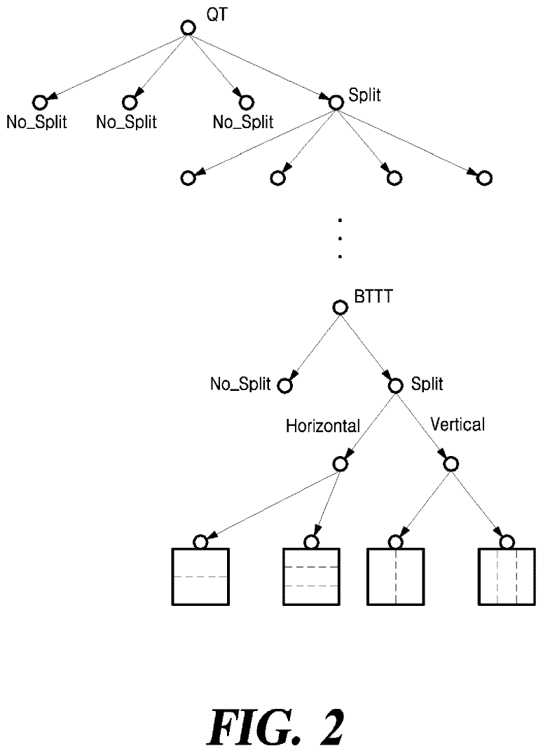

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

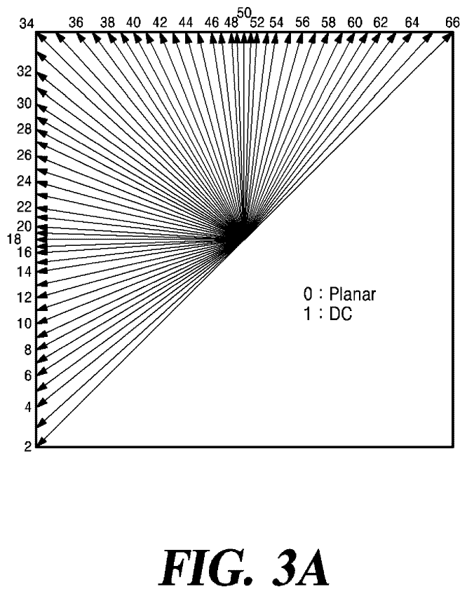

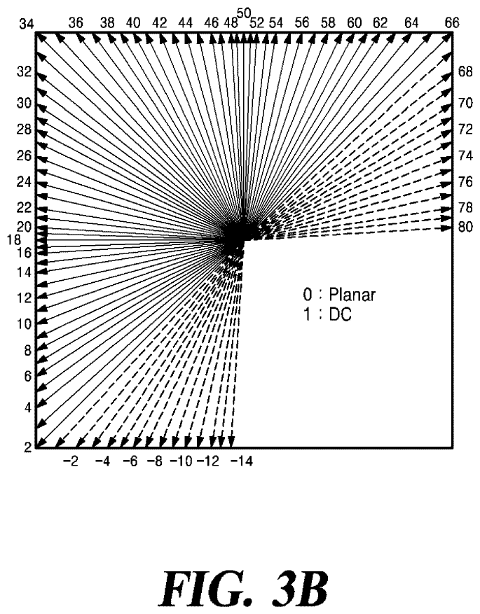

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #-1 to #-14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

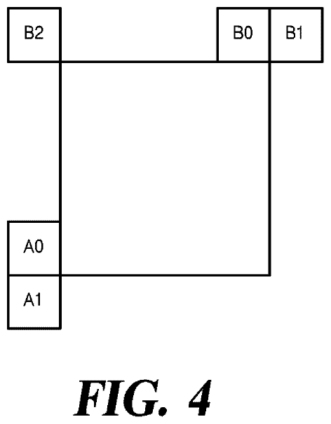

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

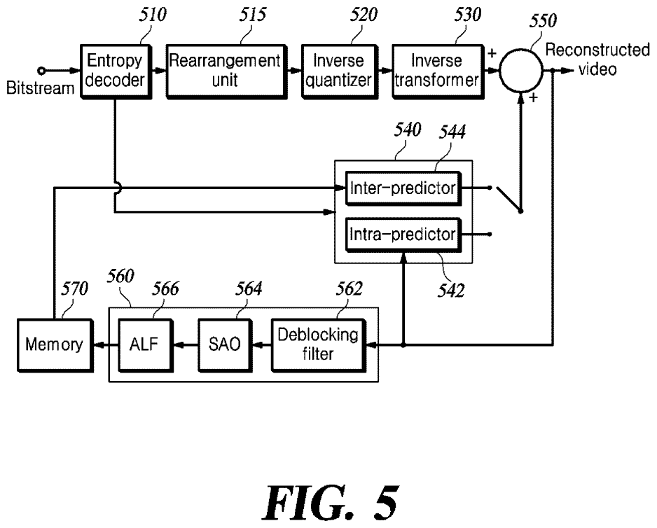

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that extract feature vectors from meta information using a deep learning-based extraction model and use the extracted feature vectors for video encoding/decoding.

The following embodiments may be performed by various constituting elements in the video encoding device. The following embodiments may also be performed by various constituting elements in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

### I. Matrix Weighted Intra Prediction (MIP)

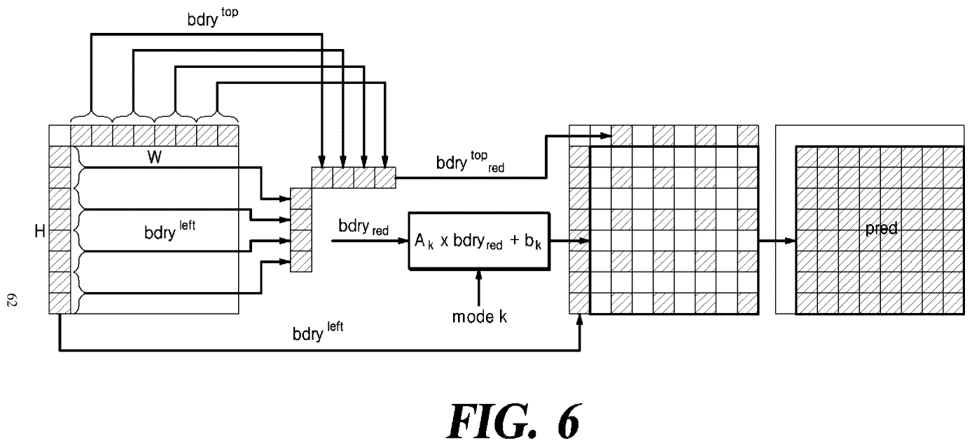

FIG. 6 illustrates matrix weighted intra prediction.

When intra prediction is performed on a current block having a width of W and a height of H, a predictor may be generated based on a predefined matrix operation using the neighboring pixels of the current block and the encoding information of the current block, as illustrated in FIG. 6. This rule-based prediction method is called Matrix Weighted Intra Prediction (MIP).

MIP generates all or part of the intra predictor using a predefined matrix operation. If part of the predictor is generated, MIP may additionally perform interpolation for up-sampling or upscaling using part of the predictor, thereby generating final intra prediction samples having the same size as the current block.

Meanwhile, MIP may selectively choose part of pixels spatially adjacent to the current block and may use the part of pixels as neighboring pixels of the current block. In another embodiment, MIP may use values derived from operations such as subsampling and downscaling for matrix operations.

FIG. 6 shows an example in which part of the predictor of the current block is generated using values derived from operations and a matrix having a smaller size than the current block. In the followings, an embodiment of MIP will be described with reference to the example of FIG. 6.

In the first step, a specific number of samples are generated from boundary samples of the current block using an average operation. For example, reduced boundary pixels

$${bdry}_{red}^{top} and {bdry}_{red}^{left} .$$

are generated from upper boundary pixels bdry^{top} and left boundary pixels bdry^{left} using a predefined rule according to the block size. Here, the predefined rule may be a combination of averaging and down-sampling. Also, a reduced boundary vector bdry_{red} is generated by combining

$$b d r {y}_{red}^{t o p} and {bdry}_{red}^{left}$$

reduced according to the predefined rule. Depending on the size and mode of the current block, the reduced boundary vector bdry_{red} may be generated as shown in Equation 1.

$$[ Equation 1 ]$$

$${bdry}_{red} = \{ \begin{matrix}[ {bdry}_{red}^{top} , {bdry}_{red}^{left} ] & for W = H = 4 and mode < 18 \\ [ {bdry}_{red}^{left} , {bdry}_{red}^{top} ] & for W = H = 4 and mode \geq 18 \\ [ {bdry}_{red}^{top} , {bdry}_{red}^{left} ] & for max ( W , H ) = 8 and mode < 10 \\ [ {bdry}_{red}^{left} , {bdry}_{red}^{top} ] & for max ( W , H ) = 8 and mode \geq 10 \\ [ {bdry}_{red}^{top} , {bdry}_{red}^{left} ] & for max ( W , H ) > 8 and mode < 6 \\ [ {bdry}_{red}^{left} , {bdry}_{red}^{top} ] & for max ( W , H ) > 8 and mode \geq 6\end{matrix}$$

Here, mode represents the MIP mode to be described later. According to Equation 1, when W=H=4 and the mode is less than 18, bdry_{red} is generated by connecting

$$bdr {y}_{red}^{t o p} and {bdry}_{red}^{left} .$$

On the other hand, when the mode is 18 or higher, bdry_{red} is generated by sequentially connecting

$$b d r {y}_{red}^{left} and {bdry}_{red}^{t o p}$$

in that order. Meanwhile, when W=H=4, the size of bdry_{red} is 4; in all other cases, the size of bdry_{red} is 8.

In the second step, as shown in FIG. 6, a predefined matrix operation is applied to the reduced boundary vector bdry_{red} to generate a reduced predictor pred_{red} for a specific portion of the current block. Here, pred_{red} is a block having a width W_{red} and a height H_{red}, which represent the down-sampled size of the current block. The width W_{red} and the height H_{red} may be determined according to the size of the current block, as shown in Equation 2.

$${W}_{red} = \{ \begin{matrix}4 & for max ( W , H ) \leq 8 \\ min ( W , 8 ) & for max ( W , H ) > 8\end{matrix} \qquad [ Equation 2 ]$$

$${H}_{red} = \{ \begin{matrix}4 & for max ( W , H ) \leq 8 \\ min ( H , 8 ) & for max ( W , H ) > 8\end{matrix}$$

Meanwhile, the reduced predictor pred_{red} may be calculated according to Equation 3 using a matrix and an offset vector.

$$p r e {d}_{r e d} = {A}_{k} \cdot {bdry}_{r e d} + {b}_{k} \qquad [ Equation 3 ]$$

Here, Aₖ is a predefined matrix, which has W_{red}·H_{red} rows and a number of columns equal to dimensions of bdry_{red}. Therefore, when W=H=4, Aₖ has 4 columns; otherwise, it has 8 columns. Meanwhile, the offset vector bₖ is a predefined vector, which has dimensions of W_{red}·H_{red}. The subscript k of Aₖ and bₖ is an index indicating one of the predefined matrices and vectors.

Aₖ and bₖ may be selected from one of the sets S₀, S₁, and S₂. At this time, the index idx(W,H) indicating a specific set is extracted based on the block size as shown in Equation 4.

$$idx ( W , H ) = \{ \begin{matrix}0 & for W = H = 4 \\ 1 & for max ( W , H ) = 8 \\ 2 & for max ( W , H ) > 8\end{matrix} \qquad [ Equation 4 ]$$

The set S₀ includes 18 matrices

$${A}_{0}^{i} ,$$

i∈{0, . . . , 17}, each of which has 16 rows and 4 columns, and 18 offset vectors

$${b}_{0}^{i} ,$$

i∈{0, . . . , 17}, each of which has a size of 16, and is used for 4×4 blocks. The set S₁ includes 10 matrices

$${A}_{1}^{i} ,$$

i∈{0, . . . , 9}, can of which has 16 rows and 8 columns, and 10 offset vectors

$${b}_{1}^{i} ,$$

i∈{0, . . . 9}, each of which has a size of 16, and is used for 4×4, 8×4, and 8×8 blocks. Also, the set S₂ includes 6 matrices

$${A}_{2}^{i} ,$$

i∈{0, . . . , 5}, each of which has 64 rows and 8 columns, and 6 offset vectors

$${b}_{2}^{i} ,$$

i∈{0, . . . , 5}, each of which has a size of 64, and is used for blocks of various sizes.

For each index idx(W,H) based on the block size, the number of MIP modes is 35, 19, and 11, respectively. Meanwhile, to reduce memory consumption, a pair of MIP modes may use the same matrix and offset vector. Therefore, in Aₖ and bₖ of Equation 3, k may be expressed by Equation 5.

$$k = \{ \begin{matrix}mode & for W = H = 4 and mode < 18 \\ mode - 17 & for W = H = 4 and mode \geq 18 \\ mode & for max ( W , H ) = 8 and mode < 10 \\ mode - 9 & for max ( W , H ) = 8 and mode \geq 10 \\ mode & for max ( W , H ) > 8 and mode < 6 \\ mode - 5 & for max ( W , H ) > 8 and mode \geq 60\end{matrix} \qquad [ Equation 5 ]$$

In the third step, linear interpolation is applied to the reduced predictor pred_{red} to generate prediction samples for the remaining positions of the current block. The linear interpolation is applied first in the horizontal direction and then proceeds in the vertical direction regardless of the size and shape of the block.

For example, to indicate whether MIP is activated, the video encoding device may encode a matrix-based prediction flag and then may transmit the encoded flag to the video decoding device. When the MIP mode is applied, the most probable mode (MPM) flag is signaled to indicate whether the prediction mode is one of the MPM modes. In the MIP, 3-MPM is applied, so that the MPM mode is encoded with a truncated binary code, and the non-MPM mode is encoded with a fixed length code (FLC). At this time, if there is a block to which MIP is not applied (which is referred to as a “regular block”) around a block to which MIP mode is applied, the MPM derivation of the block to which MIP mode is applied may be performed using a mapping table. In other words, the mapping table is used to derive MIP modes with similar characteristics from neighboring blocks to which the regular mode is applied. The MIP mode derived in this way is used to derive the MPM of the block to which MIP mode is applied.

Also, if a neighboring block with MIP applied is present around a regular block, MPM derivation for the regular block may be performed using a mapping table. In other words, the mapping table is used to derive the regular mode with similar characteristics from the MIP mode of the neighboring block to which MIP is applied. The regular mode derived in this way is used to derive MPM of the regular block. Similarly, even if the luma block at the same position used in the derivation of chroma DM applies MIP, the regular mode may be derived using the mapping table, and the derived regular mode may be used in the derivation of the chroma DM.

Mapping between the regular mode and the MIP mode using the mapping table may be expressed as shown in Equation 6.

$${Predmode}_{ALWIP} = map\_angular \_to {\_alwip}_{i d x} [ p r e d m o d {e}_{A n g u l a r} ] \qquad [ Equation 6 ]$$

$$pred m o d {e}_{A n g u l a r} = map\_alwip \_to {\_angular}_{i d x ( P U )} [ {predmode}_{ALWIP} ]$$

Here, affine linear weighted intra prediction (ALWIP) is another representation of MIP. In Equation 6, the former equation maps the regular mode to the MIP mode, while the latter equation maps the MIP mode to the regular mode.

Part of the mapping table that maps the regular mode to the MIP mode for each index idx(W,H) based on the block size may be expressed as shown in Table 1.

TABLE 1

| IntraPredModeY | MipSizeId | | |
|---|---|---|---|
| [xNbX][yNbX] | 0 | 1 | 2 |
| 0 | 17 | 0 | 5 |
| 1 | 17 | 0 | 1 |
| 2, 3 | 17 | 10 | 3 |
| 4, 5 | 9 | 10 | 3 |
| 6, 7 | 9 | 10 | 3 |
| 8, 9 | 9 | 10 | 3 |
| 10, 11 | 9 | 10 | 0 |
| 12, 13 | 17 | 4 | 0 |
| . . . | . . . | . . . | . . . |
| 56, 57 | 34 | 13 | 9 |
| 58, 59 | 26 | 1 | 8 |
| 60, 61 | 26 | 1 | 8 |
| 62, 63 | 26 | 1 | 8 |
| 64, 65 | 26 | 1 | 8 |
| 66 | 26 | 1 | 8 |

In Table 1, MipSizeID is the same value as the index idx(W,H). [xNbX][yNbX] represents the position of a neighboring block, and IntraPreModeY[xNbX][yNbX] represents the regular mode at the corresponding position. According to Table 1, regular intra prediction modes (0 to 66 in FIG. 3A) may be mapped to the corresponding MIP modes.

Part of the mapping table that maps the MIP mode to the regular mode for each index idx(W,H) based on the block size may be expressed as shown in Table 2.

TABLE 2

| IntraPredModeY | MipSizeId | | |
|---|---|---|---|
| [xNbX][yNbX] | 0 | 1 | 2 |
| 0 | 0 | 0 | 1 |
| 1 | 18 | 1 | 1 |
| 2 | 18 | 0 | 1 |
| 3 | 0 | 1 | 1 |
| . . . | . . . | . . . | . . . |
| 9 | 2 | 0 | 50 |
| 10 | 18 | 1 | 0 |
| 11 | 12 | 0 | |
| 12 | 18 | 1 | |
| 13 | 18 | 0 | |
| 14 | 1 | 44 | |
| . . . | . . . | . . . | |
| 17 | 0 | 1 | |
| 18 | 0 | 0 | |
| 19 | 50 | | |
| 20 | 0 | | |
| 21 | 50 | | |
| 22 | 0 | | |
| . . . | . . . | | |
| 33 | 50 | | |
| 34 | 50 | | |

In Table 2, MipSizeID is the same value as the index idx(W,H). [xNbX][yNbX] represents the position of a neighboring block, and IntraPreModeY[xNbX][yNbX] represents the regular mode at the corresponding position. According to Table 2, MIP modes corresponding to the respective indices idx(W,H) may be mapped to the regular intra prediction modes (0 to 66 in FIG. 3A).

In another example, to indicate whether MIP is activated, the video encoding device may encode a matrix-based prediction flag and then may transmit the encoded flag to the video decoding device. At this time, MIP may be performed separately from the regular intra prediction mode that uses MPM. Additionally, the video encoding device may encode the MIP mode to indicate one of predefined matrices and one of predefined vectors and then may transmit the encoded MIP mode to the video decoding device. Meanwhile, if a block with MIP applied is present around a regular block, the neighboring block with MIP applied is assumed to be in the Planar mode, and an MPM candidate list of the regular block may be generated.

### II. Multiple Transform Selection (MTS)

When a transform is applied in HEVC, DCT-II is used as a transform kernel (in the following, used interchangeably with transform type) to transform residual signals of a transform block (TB). However, to apply a more appropriate transform technique depending on the diversity of residual signal characteristics, Multiple Transform Selection (MTS) may be used. MTS determines one or two optimal types among multiple transform types and then transforms a block according to the determined transform type. For example, in VVC, as shown in Table 3, in addition to DCT-II, two other transform types, DCT-VIII and DST-VII, are added so that residual signals may be transformed in various ways.

TABLE 3

| Transform Type | Basis function Tᵢ(j), i, j = 0, 1, ... , N − 1 |
|---|---|
| DCT-II | ${T}_{i} ( j ) = {ω}_{0} \cdot \sqrt{\frac{2}{N}} \cdot cos ( \frac{π \cdot i \cdot ( 2 j + 1 )}{2 N} )$ |
| | $where , {ω}_{0} = \{ \begin{matrix}\sqrt{\frac{2}{N}} & i = 0 \\ 1 & i \neq 0\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

Here, basis functions constitute the transform matrix that defines each transform type. In what follows, DCT-II, DCT-VIII, and DST-VII will be used interchangeably with DCT2, DCT8, and DST7, respectively.

The flag for MTS may be determined at the CU level, and the transform type may be signaled in various ways as shown in Table 4 depending on whether the prediction mode is intra/inter prediction and whether the prediction mode is in the horizontal/vertical direction.

TABLE 4

| | | | Intra/inter | |
|---|---|---|---|---|
| MTS_CU_flag | MTS_Hor_flag | MTS_Ver_flag | Horizontal | Vertical |
| 0 | | | DCT2 | DCT2 |
| 1 | 0 | 0 | DST7 | DST7 |
| | 0 | 1 | DCT8 | DST7 |
| | 1 | 0 | DST7 | DCT8 |
| | 1 | 1 | DCT8 | DCT8 |

First, if MTS_CU_flag is 0, DCT2 transform type is applied in the horizontal and vertical directions. On the other hand, if MTS_CU_flag is not 0, different transform types may be applied in the horizontal and vertical directions depending on the combination of MTS_Hor_flag and MTS_Ver_flag.

Meanwhile, MTS index (mts_idx) may be derived according to Table 4. For example, if MTS_CU_flag is 0, mts_idx may be set to 0. Also, if MTS_CU_flag is 1, MTS index may be set in the order of Table 4 depending on the combination of MTS_Hor_flag and MTS_Ver_flag. For example, if MTS_Hor_flag=0 and MTS_Ver_flag=0, mts_idx may be set to 1; if MTS_Hor_flag=1 and MTS_Ver_flag=1, mts_idx may be set to 4.

### III. Feed-Forward Network

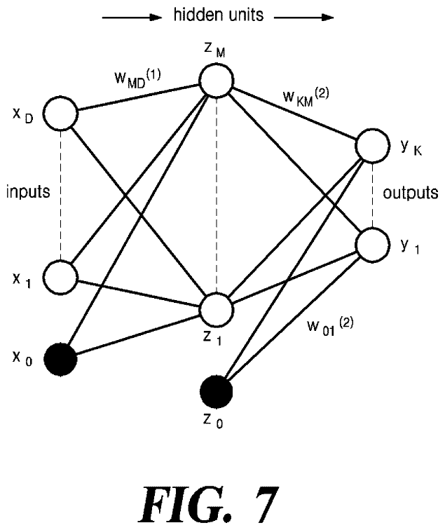

A deep learning-based neural network is composed of a plurality of neurons and edges connecting the neurons, as shown in the example of FIG. 7. The input layer and the output layer of the neural network are composed of a single layer, and the hidden layer may include one or more layers. One hidden layer includes one or more hidden units (or hidden nodes). Also, each edge has a different weight. Also, an activation function may be used in the process of propagating output values from one layer to the next layer. Typical activation functions include the sigmoid function, the tangent hyperbolic function, and the Rectified linear unit (Relu) function.

As shown in the example of FIG. 7, a two-layer neural network model with a basic forward network structure provides an output vector y by passing an input vector X through the intermediate hidden unit. In the feed-forward network structure, the value produced at an arbitrary node located in the output layer may be represented as shown in Equation 7.

$${y}_{k} ( x , W ) = σ ( {\sum }_{j = 0}^{M} {w}_{k j}^{( 2 )} \cdot h ( {\sum }_{i = 0}^{D} {w}_{j i}^{( 1 )} \cdot {x}_{i} ) ) \qquad [ Equation 7 ]$$

At this time, W¹ and W² are weight matrices, which correspond to the edges connecting the input vector and the hidden units and the edges connecting the hidden units and the output vector, respectively.

$${w}_{j i}^{( 1 )} and {w}_{k j}^{( 2 )}$$

represent the elements of W¹ and W², respectively. yₖ represents the element of the output vector y. x₀ and z₀ represent the bias units of the input layer and the hidden layer, respectively. Therefore, D represents the dimension of the input vector X, M represents the number of hidden units, and K represents the dimension of the output vector y. Also, h and o are activation functions applied to the hidden layer and the output layer, respectively. Meanwhile, the activation function is not necessarily applied to the outputs of the hidden layer and the output layer. If the activation function is not used, Equation 7 includes an operation corresponding to the weight matrix multiplication between W¹ and W².

The process of calculating weights for edges based on training data and labels is called training. Training may usually be performed using the stochastic gradient descent (SGD) algorithm based on the back propagation algorithm. The process of calculating output in the feed-forward direction using the weights, which are parameters calculated according to training, is called inference or testing.

The following embodiments are described with reference to the video decoding device but may also be performed by the video encoding device, as described above.

### IV. Embodiments According to the Present Disclosure

In the followings, a combination of one or more parameters used in the compression process of a current block is defined as meta information, and a method of using the meta information for video encoding/decoding will be described. The present embodiment includes a method of generating meta information, a method of generating a meta information feature vector using the meta information, and a method of encoding/decoding the current block using the meta information feature vector.

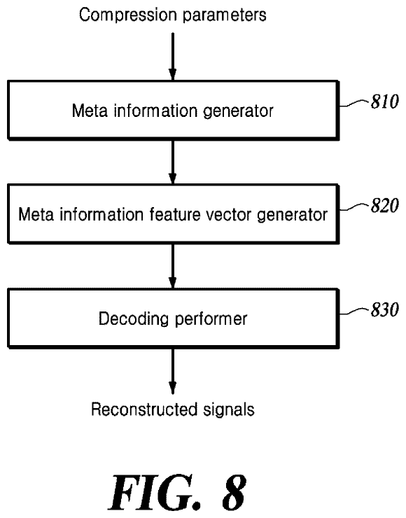

FIG. 8 illustrates an video decoding device that uses meta information according to one embodiment of the present disclosure.

To decode the current block using the meta information, the video decoding device may include a meta information generator 810, a meta information feature vector generator 820, and a decoding performer 830.

The meta information generator 810 generates a combination of one or more parameters used in the compression process of the current block as meta information, as described above. Compression parameters are composed of syntax elements and their derivatives, including block size, block structure, reference samples, intra prediction mode, inter prediction mode, motion vector, and quantization parameters. Meanwhile, compression parameters may be used for both encoding and decoding of the current block.

The meta information feature vector generator 820 inputs meta information into the deep learning-based extraction model to generate a meta information feature vector with a size of K×1. Here, the extraction model, which is a neural network, may employ a feed-forward network as described above. At this time, the feed-forward network may be used while the activation function being excluded. The meta information feature vector may be composed of a result of a mapping table, a mode according to block encoding conditions, or on the like used in the existing VVC.

The decoding performer 830 uses the meta information feature vector for decoding the current block. For example, the decoding performer 830 may perform the operation of the predictor 540. Alternatively, the decoding performer 830 may perform the operation of the inverse transformer 530. In other words, the decoding performer 830 may be any component within the video decoding device, which may utilize the meta information feature vector for decoding of the current block.

Also, the generation and use of the meta information illustrated in FIG. 8 may also be utilized by constituting elements, for example, on the decoding path within the video encoding device. For example, the decoding performer 830 may perform the operation of the predictor 120 within the video encoding device. Alternatively, the decoding performer 830 may perform the operation of the inverse transformer 165 within the video encoding device.

According to the present embodiment, compared to the method of determining the encoding mode and index based on the mapping table used in the existing VVC, the existing process may be replaced to allow the use of more diverse compression parameters without involving the mapping table.

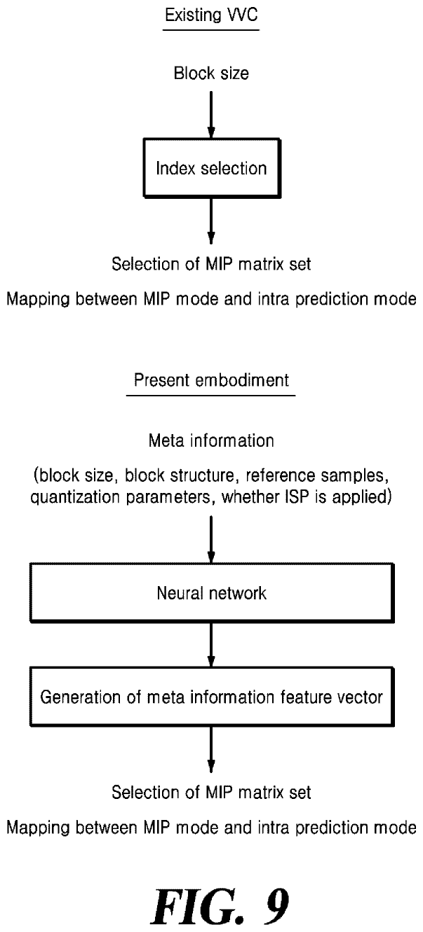

For example, as shown in the top example of FIG. 9, MIP prediction in the existing VVC technology derives the index idx as shown in Equation 4 and then selects a set S_{idx} including a matrix and an offset vector according to the derived index. At this time, the idx value may be derived according to the block size as shown in Equation 4. However, if different idxs are set based on block structures, reference samples, quantization parameters, and other parameters that may be used in the intra prediction process, the number of cases may increase significantly. At this time, as shown in the bottom example of FIG. 9, the present embodiment enables efficient handling of the various cases described above.

Also, the present embodiment may replace the mapping table used in MIP. For example, the present embodiment may replace the mapping relationship between the MIP mode and the intra prediction mode based on the size of the block to which the MIP is applied, as shown in Tables 1 and 2. In other words, although only the size of the block to which the MIP mode is applied is used in Table 1 and Table 2, the present embodiment may implement the mapping relationship by utilizing more diverse compression parameters.

Also, the present embodiment may generate an intra prediction mode that replaces the MIP mode. The present embodiment may map the meta information to the replacing index repIdx using the feed-forward network. Here, the meta information is the reference samples of the current block, and repIdx may indicate one of the 67 intra prediction modes according to the example of FIG. 3a. Later, the intra prediction mode mapped to the replacing index may be used to derive the MPM when intra prediction is performed on a block. For example, if a luma block located to the left of or above the current block is predicted using MIP, the video decoding device may apply the replacing index of the corresponding luma block to the process of constructing the MPM list.

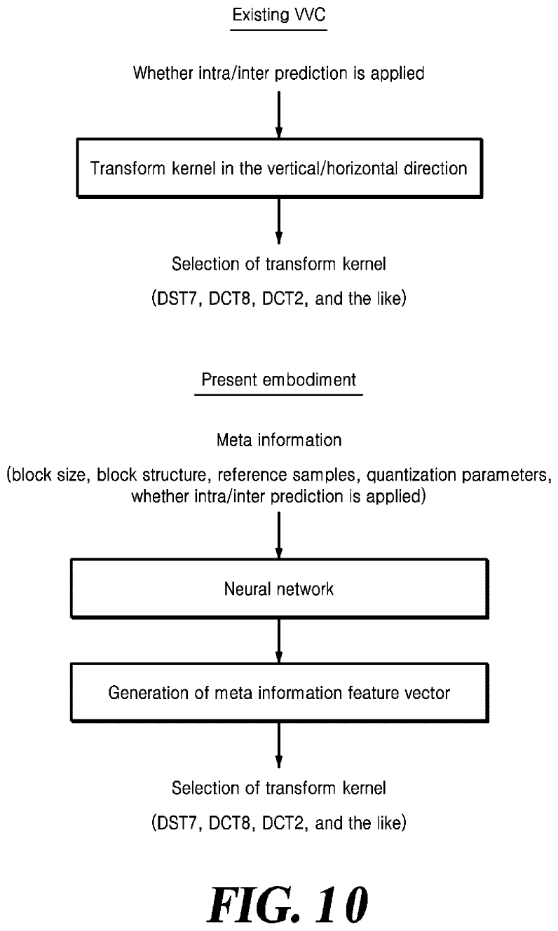

In another example, the present embodiment may replace the MTS selection process of VVC, as shown in the top example of FIG. 10. For example, Table 4 shows the mapping relationship related to the transform kernel selection in the VVC. In other words, whether the inter prediction and intra prediction modes are selected is checked, and depending on whether transform is applied in the horizontal direction and vertical direction, one of DCT2, DST7, and DCT8 may be selected as the transform kernel. On the other hand, as shown in the bottom example of FIG. 10, by applying the present embodiment, a mapping relationship between compression parameters and transform kernels may be established by utilizing more diverse compression parameters.

The application of the present embodiment to the MIP and MTS is merely an example; the present embodiment may be broadly applied to mapping tables used, mode settings according to the block encoding conditions, and on the like in the existing VVC.

Meanwhile, the extraction model within the meta information feature vector generator 820 may be trained in advance by using the training meta information and the corresponding label. The label may be, for example, idx in the MIP or the transform kernel in the MTS as described above. In the training process, the weights of the extraction model may be updated using a loss function based on the difference between the output generated by the extraction model and the label. Since the video encoding device transfers the weights to the video decoding device, the extraction model may be shared between the video encoding device and the video decoding device.

In the following, a method for generating meta information will be described. The meta information represents video compression parameters used in the video decoding process as a vector. At this time, the video compression parameters include parameters decoded at a higher level, such as VPS, SPS, adaptive parameter set (APS), video picture level, and video slice level decoded from a bitstream. Also, the video compression parameters may include all or part of information related to the size of the video block, partition information, intra prediction, inter prediction, motion vector, and the like decoded at the current block level.

For example, an example of representing the compression parameters as a vector will be described. In other words, the video decoding device may generate meta information by representing the compression parameters as a vector. In what follows, a vector represents a combination of one or more bits.

First, all block structures used in the video decoding process are represented as vectors. For example, when block structures of 2N×2N, 2N×N, N×2N, and N×N are used, each block structure is represented as a vector of size 2, such as 00, 01, 10, and 11. In the VVC, blocks are partitioned based on quad-tree (QT), binary-tree (BT), and ternary-tree (TT) structures. Meta information represents all block structures available to the video encoding device and the video decoding device as vectors.

Also, the size of the block determined in the video decoding process may be represented as a vector. The width and height of the block may be used, and conditions regarding the width/height may also be used. For example, the case where one of the width and height of the block is greater than or equal to 16 may be represented as 0, while all other cases may be represented by 1. Alternatively, the case where the width and height of the block are the same may be represented by 0, while the case where the width and the height are different may be represented by 1.

Also, the quantization parameter (QP) used in the video decoding process is represented as a vector. For example, when the quantization parameter is a single number belonging to the range of 0 to Q−1 (where Q is a natural number), vectors having a size of floor (log₂Q)+1 may be generated, and the quantization parameter may be mapped to one of the vectors. Here, the floor function rounds a real number down to the smallest natural number. In another example, instead of representing the quantization parameter as a vector having a size of floor (log₂Q)+1, the range of Q may be partitioned into equal sections, and the partitioned sections may be represented as vectors. Then, the quantization parameter may be mapped to one of the vectors. For example, when the range is partitioned into 8 equal parts, the range of Q is partitioned into [0, Q/8-1], [Q/8, 2Q/8-1], . . . , [7Q/8, Q−1], and each section is represented by a vector of size 3. For example, if the range of Q is 64, QP=27 is represented by a vector of 011.

Also, the direction of intra prediction mode used in the video decoding process is represented as a vector. For example, when the direction is a single number belonging to the range of 0 to P−1 (where P is a natural number), vectors having a size of floor (log₂P)+1 may be generated, and the intra prediction mode may be mapped to one of the vectors. In another example, instead of representing the direction of intra prediction mode as a vector having a size of floor (log₂P)+1, the range of P may be partitioned into equal sections, and the partitioned sections may be represented as vectors. Then, the direction of intra prediction mode may be mapped to one of the vectors. For example, when the range is partitioned into 8 equal parts, the range of P is partitioned into [0, P/8-1], [P/8, 2P/8-1], . . . , [7P/8, P−1], and each section is represented by a vector of size 3. For example, if the range of P is 64, intra prediction mode 12 is represented by a vector of 001.

Also, the motion vector used in the video decoding process is represented as a vector. For example, when the motion vector is represented by a vector with 6 elements, MV=(m0, m1, m2, m3, m4, m5, m6). Here, m0 indicates whether the motion vector is in the x direction or y direction. For example, when m0 is 0, it indicates that the motion vector is in the x direction (i.e., a motion vector closer to the x-axis, where absolute value of x is greater than or equal to the absolute value of y); when m0 is 1, it indicates that the motion vector is in the y direction (i.e., a motion vector closer to the y-axis, where the absolute value of y is greater than the absolute value of x). m1 is used to determine the resolution of the motion vector. For example, when m1 is 0, the motion vector has a resolution of integer precision; when m1 is 1, the motion vector has a resolution of fractional precision.

Also, m2 indicates the reference picture index of the motion vector. m3 indicates the reference picture list of the motion vector. For example, when m3 is 0, it indicates that the reference picture list is L0 list; when m3 is 1, it indicates that the reference picture list is L1 list. m4 indicates the sign of the motion vector. In other words, m4 may be set to 0 or 1 based on the sign of the motion vector. m5 indicates the size of the motion vector.

Among vector elements of meta information for the motion vector, m0, m1, m3, and m4 may be represented by 1-bit, and m2 and m5 may be represented by a plurality of bits.

In another example, compression parameters parsed during the video decoding process may be used as meta information without modification. In other words, the video decoding device may use the encoding mode, flag, index information, and derived parameters used in the decoding process as meta information without modification.

In the case of intra prediction, the decoded directional prediction mode p is used as meta information.

Whether intra prediction or inter prediction is applied to the current block is indicated by 0 or 1.

When intra prediction is applied and the Intra sub-partition (ISP) mode is used, the ISP mode information is used as meta information.

For example, if the quantization parameter is 24, 24 is used as meta information.

If a specific index within a filter parameter set A of an in-loop filter is used for decoding, the corresponding index is used as meta information.

If MTS mode is used for transform, an MTS index or a flag for the MTS is used as meta information.

In the following, an example of generating a meta information feature vector from the meta information will be descried.

For example, the video decoding device generates a meta information input vector X by concatenating one or more pieces of meta information. For example, in the example described above, if the current block size is 32×32, the structure is set to 2N×2N, and vector 00 is selected. Also, since one of the width and height of the block is greater than or equal to 16, the third bin is selected as 0, and thus, the final input meta information vector may be represented as 000. For example, in the example of FIG. 7, 0, 0, 0 may be input to x₁, x₂, and x₃.

The video decoding device may input the meta information vector into a neural network to generate a meta information feature vector y. y may be used to select a mode during the encoding and decoding process, as in the examples of FIGS. 9 and 10, or to express a query within a mapping table. For example, in the example of FIG. 9, if y is 0, S₀ is selected from the sets of S₀, S₁, and S₂ of MIP. Also, in the example of FIG. 10, if y is 00, the kernels in the horizontal and vertical directions may be selected as DCT2.

In another example, as described above, the video decoding device may use the parsed compression parameters as meta information without modification. For example, if the quantization parameter is 27, the length of the current block is 16, and the intra prediction mode is 12, 27, 16, and 12 may be input to x₁, x₂, and x₃ in the example of FIG. 7.

In another example, in addition to inputting the meta information, the video decoding device may input neighboring reference pixels of the current block into the neural network to generate a meta information feature vector. For example, in addition to inputting 000 to x₁, x₂, and x₃ in the example of FIG. 7, W reference pixels located above the current block may be input to W input nodes among the remaining input nodes. Also, H reference pixels located at the left side of the current block may be input to H input nodes.

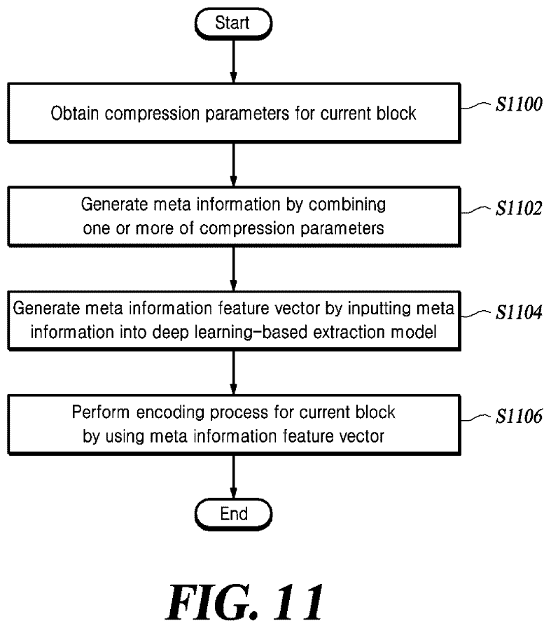

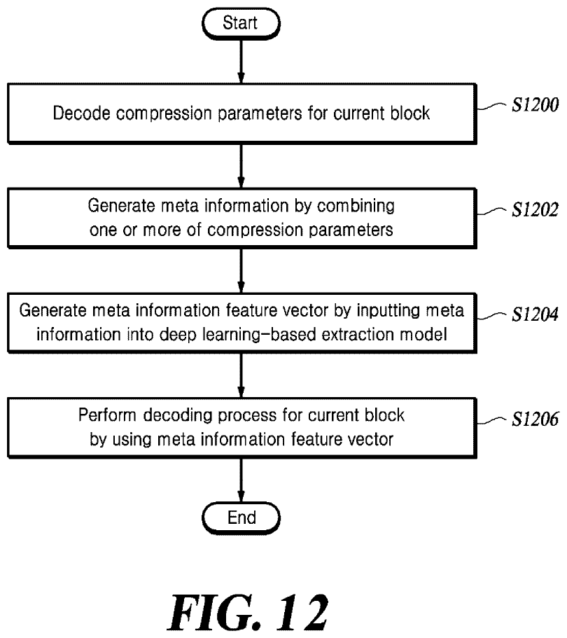

In the followings, a method of encoding/decoding a current block based on meta information will be described using the illustrations of FIGS. 11 and 12.

FIG. 11 illustrates a method for encoding a current block performed by an video encoding device according to one embodiment of the present disclosure.

The video encoding device obtains compression parameters for the current block S1100.

Here, the compression parameters include those parameters configured in consideration of the rate-distortion optimization at the higher level of the current block. Also, the compression parameters may include information determined in consideration of the rate-distortion optimization at the level of the current block. This information may include all or part of information related to the block structure of the current block, the size of the current block, partition information, intra prediction, inter prediction, and motion vector.

The video encoding device generates meta information by combining one or more of the compression parameters S1102. Here, the meta information may include each compression parameter without modification or may include a vector generated from each compression parameter.

The video encoding device inputs the meta information into a deep learning-based extraction model to generate a meta information feature vector S1104.

The video encoding device may generate an input vector by concatenating one or more vectors of each compression parameter and may input the generated input vector into the extraction model. Here, the extraction model may be the feed-forward network as described above. The meta information feature vector may be composed of a result of a mapping table, a mode according to block encoding conditions, and on the like used in the existing VVC.

Meanwhile, the extraction model may be trained in advance by using the training meta information and the corresponding label. The label may be, for example, idx in the MIP. Since the video encoding device transfers the weights to the video decoding device, the extraction model may be shared between the video encoding device and the video decoding device.

The video encoding device performs the encoding process for the current block by using the meta information feature vector S1106.

For example, when the encoding process is based on MIP, the meta information includes the block structure of the current block, the size of the current block, reference samples of the current block, quantization parameters, and parameters related to intra prediction; and the meta information feature vector may be idx indicating one of the sets. At this time, the sets include matrices and vectors used for the application of MIP.

Also, an intra prediction mode replacing the MIP mode may be generated. Here, the meta information may be the reference samples of the current block, and the meta information feature vector may be composed of repIdx, a replacing index indicating the intra prediction mode. Later, the intra prediction mode mapped to the replacing index may be used to derive the MPM when intra prediction is performed on a block. For example, if a luma block located to the left of or above of the current block is predicted using MIP, the video encoding device may apply the replacing index of the corresponding luma block to the process of constructing the MPM list.

FIG. 12 illustrates a method for decoding a current block performed by an video decoding device according to one embodiment of the present disclosure.

The video decoding device decodes compression parameters for the current block from a bitstream S1200.

Here, the compression parameters include those parameters decoded at the higher level of the current block. Also, the compression parameters may include information decoded at the level of the current block. At this time, the decoded information may include all or part of information related to the block structure of the current block, the size of the current block, reference samples of the current block, partition information, intra prediction, inter prediction, and motion vector.

The video decoding device generates meta information by combining one or more of the compression parameters S1202. Here, the meta information may include each compression parameter without modification or may include a vector generated from each compression parameter.

The video decoding device inputs the meta information into a deep learning-based extraction model to generate a meta information feature vector S1204.

The video decoding device may generate an input vector by concatenating one or more vectors of each compression parameter and may input the generated input vector into the extraction model. Here, the extraction model may be the feed-forward network as described above. The meta information feature vector may be composed of a result of a mapping table, a mode according to block encoding conditions, and on the like used in the existing VVC.

The video decoding device performs the decoding process for the current block by using the meta information feature vector S1206.

For example, when the decoding process is based on MIP, the meta information includes the block structure of the current block, the size of the current block, reference samples of the current block, quantization parameters, and parameters related to intra prediction; and the meta information feature vector may be idx indicating one of the sets. At this time, the sets include matrices and vectors used for the application of MIP.

Also, an intra prediction mode replacing the MIP mode may be generated. Here, the meta information may be the reference samples of the current block, and the meta information feature vector may be composed of repIdx, a replacing index indicating the intra prediction mode. Later, the intra prediction mode mapped to the replacing index may be used to derive the MPM when intra prediction is performed on a block. For example, if a luma block located to the left of or above of the current block is predicted using MIP, the video decoding device may apply the replacing index of the corresponding luma block to the process of constructing the MPM list.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

530: inverse transformer
540: predictor
810: meta information generator
820: meta information feature vector generator
830: decoding performer

1. A method for reconstructing a current block, performed by a video decoding device, the method comprising:
decoding compression parameters for the current block from a bitstream;
generating meta information by combining one or more of the compression parameters, wherein the meta information comprises each compression parameter without modification or comprises a meta information vector generated from each compression parameter;
generating a feature vector of the meta information by inputting the meta information into a deep learning-based extraction model; and
performing a decoding process for the current block by using the feature vector.

2. The method of claim 1, wherein the compression parameters include parameters decoded at a higher level of the current block and information decoded at the level of the current block, wherein the decoded information includes all or part of information related to block structure of the current block, size of the current block, partition information, intra prediction, inter prediction, and motion vector.

3. The method of claim 1, wherein generating the meta information comprises:
when the compression parameter is size of the current block, generating the meta information vector based on width and height of the current block or conditions related to the width and height.

4. The method of claim 1, wherein generating the meta information comprises:
when the compression parameter is a quantization parameter and the quantization parameter is a single number belonging to the range of 0 to Q−1 (where Q is a natural number), generating vectors having a size of floor (log₂Q)+1, and mapping one of the vectors to a meta information vector of the quantization parameter.

5. The method of claim 1, wherein generating the meta information comprises:
when the compression parameter is a quantization parameter, generating vectors corresponding to sections obtained by partitioning the range of the quantization parameter, and mapping one of the vectors into a meta information vector of the quantization parameter.

6. The method of claim 1, wherein generating the meta information comprises:
when the compression parameter is a direction of intra prediction mode, and the direction is a single number belonging to the range of 0 to P−1 (where P is a natural number), generating vectors having a size of floor (log₂P)+1, and mapping one of the vectors to a meta information vector of the direction.

7. The method of claim 1, wherein generating the meta information comprises:
when compression parameter is a direction of intra prediction mode, generating vectors corresponding to sections obtained by partitioning the range of the intra prediction mode, and mapping one of the vectors into a meta information vector of the direction.

8. The method of claim 1, wherein generating the meta information comprises:
when the compression parameter is the motion vector, representing the motion vector by the meta information vector,
wherein constituting elements of the meta information vector include direction of the motion vector, resolution of the motion vector, a reference picture index of the motion vector, a reference picture list of the motion vector, a sign of the motion vector, and size of the motion vector.

9. The method of claim 1, wherein generating the meta information comprises:
using intra prediction mode, whether intra prediction or inter prediction is applied, information of intra sub-partition (ISP) mode, a quantization parameter, a multiple transform selection (MTS) index, a flag for the MTS, or an index for a parameter set of an in-loop filter as meta information without modification.

10. The method of claim 1, wherein generating the feature vector of the meta information comprises:
generating an input vector by combining one or more of meta information vectors and inputting the input vector to the extraction model to generate the feature vector.

11. The method of claim 10, wherein generating the feature vector of the meta information comprises:
generating the feature vector by inputting neighboring reference pixels of the current block to the extraction model in addition to the input vector.

12. The method of claim 1, wherein when the decoding process is based on matrix weighted intra prediction, the meta information includes block structure of the current block, size of the current block, reference samples of the current block, quantization parameters, and parameters related to intra prediction; and the feature vector is an index indicating one of sets, wherein the sets include matrices and vectors used for application of the matrix weighted intra prediction.

13. The method of claim 1, wherein when the decoding process is based on matrix weighted intra prediction, the meta information includes reference samples of the current block, and the feature vector is a replacing index that indicates one of intra prediction modes.

14. The method of claim 13, wherein performing the decoding process for the current block comprises:
when the decoding process is based on intra prediction of the current block, and a luma block located to the left of or above of the current block is predicted according to the matrix weighted intra prediction, applying the replacing index of the corresponding luma block to construct a most probable mode (MPM) list of the current block.

15. A method for encoding a current block, performed by a video encoding device, the method comprising:
obtaining compression parameters for the current block;
generating meta information by combining one or more of the compression parameters, wherein the meta information comprises each compression parameter without modification or comprises a meta information vector generated from each compression parameter;
generating a feature vector of the meta information by inputting the meta information into a deep learning-based extraction model; and
performing an encoding process for the current block by using the feature vector.

16. The method of claim 15, wherein the compression parameters include parameters configured at a higher level of the current block and information determined at the level of the current block, wherein the determined information includes all or part of information related to block structure of the current block, size of the current block, partition information, intra prediction, inter prediction, and motion vector.

17. A computer-readable recording medium storing a bitstream generated by a video encoding method, the video encoding method comprising:
obtaining compression parameters for current block;
generating meta information by combining one or more of the compression parameters, wherein the meta information comprises each compression parameter without modification or comprises a meta information vector generated from each compression parameter;
generating a feature vector of the meta information by inputting the meta information into a deep learning-based extraction model; and
performing an encoding process for the current block by using the feature vector.
